(19) United States
(12) Patent Application Publication
(10) Pub. No.: US 2023/0081805 A1
(43) Pub. Date: Mar. 16, 2023

(54) CONNECTOR STRUCTURE FOR AN INNER-TUBE DECORATIVE LAMP OF A CHRISTMAS TREE

(71) Applicant: KING TREE HANDICRAFTS (SHENZHEN) CO., LTD., Shenzhen (CN)

(72) Inventor: XIAOPENG HAO, Shenzhen (CN)

(21) Appl. No.: 17/447,926

(22) Filed: Sep. 16, 2021

(51) Int. Cl. F21V 23/06; F21V 21/16; F21S 4/10

(52) U.S. Cl. CPC F21V 23/06; F21V 21/16; F21S 4/10; A47G 33/06

(57) ABSTRACT

A connector structure for an inner-tube decorative lamp of a Christmas tree is disclosed. The connector structure includes a male connector and a female connector. A first and a second male connector fixing plastic portion are respectively disposed on both sides of the male connector, and a male connector insertion groove and a rubber sleeve groove are defined in each of the first and second male connector fixing plastic portions. A first bolt mounting hole is defined in each of the first and second male connector fixing plastic portions. A first fixing bolt is disposed to pass through the inside of the first bolt mounting hole. A rubber sleeve is sleeved on one end of the male connector, and a first wire is connected to one end of the male connector.

### TECHNICAL FIELD

This disclosure relates to the technical field of lamp plugs, and more particularly relates to a connector structure for an inner-tube decorative lamp of a Christmas tree.

### BACKGROUND

The Christmas tree is widely used as a holiday ornament for Christmas. To decorate the Christmas tree, multiple LED light bars will be hung on the Christmas tree. When the LED light bar is connected, it is electrically connected through a connector. Through the insertion and connection of the male connector to the female connector, the power supply connector can achieve the conduction of power. The male connector has two protruding electrodes, while the female connector has two insertion holes matched with the electrodes, and electrode terminals are disposed in the insertion holes. Most of the existing plugs are hung outside on the tree, while some are buried inside, but they all have a big disadvantage. Because the Christmas tree is relatively tall, shaking of the Christmas tree may cause poor contact between the electrodes with the electrode terminals in the insertion holes. If the cable interface is unstable, the power will be easily cut off. Furthermore, because the female connector generally only has one set of plug holes, there is no spare plug hole and so maintenance is needed, which is however quite inconvenient, causing inconvenience of use.

### SUMMARY

In view of the above shortcomings of the related art, the present disclosure provides a connector structure for an inner-tube decorative lamp of a Christmas tree, which can solve the problem “most of the existing plugs are hung outside on the tree, while some are buried inside. Because the Christmas tree is relatively tall, shaking the Christmas tree may cause poor contact between the electrodes and the electrode terminals in the insertion holes, and the instability of the cable interface will easily cut off the power”. The present disclosure effectively solves the problems of the related art by providing a connector structure for an inner-tube decorative lamp of the Christmas tree.

In order to achieve the objective of the above connector structure for an inner-tube decorative lamp of a Christmas tree Christmas tree, the present disclosure provides the following technical solutions. There is provided a connector structure for an inner-tube decorative lamp of a Christmas tree Christmas tree. The connector structure includes a male connector and a female connector. A first male connector fixing plastic portion and a second male connector fixing plastic portion are respectively disposed on both sides of the male connector. A male connector insertion groove and a rubber sleeve groove are defined in each of the first male connector fixing plastic portion and the second male connector fixing plastic portion. A first bolt mounting hole is defined in a housing of each of the first male connector fixing plastic portion and the second male connector fixing plastic portion. A first fixing bolt is arranged to go through the first bolt mounting hole. A rubber sleeve is sleeved on the outer circumference of one end of the male connector. A first wire is coupled to one end of the male connector. A first LED lamp is installed at one end of the first wire. An upper main insertion pipe is disposed outside the first male connector fixing plastic portion and the second male connector fixing plastic portion. A second bolt mounting hole is defined in the surface of the upper main insertion pipe, and a power cord clamping slot is defined in the surface of the upper main insertion pipe. A power cord clamping button is disposed on one side of the power cord clamping slot. A first female fixing plastic portion and a second female fixing plastic portion are respectively disposed on both sides of the female connector. A female connector insertion groove is defined in each of the first female fixing plastic portion and the second female fixing plastic portion. A third bolt mounting hole is defined in the housing of each of the first female fixing plastic portion and the second female fixing plastic portion. A second fixing bolt is arranged through the third bolt mounting hole. One end of the female connector is coupled to a second wire, and one end of the second wire is installed with a second LED lamp. A lower main insert tube is disposed outside the first female fixing plastic portion and the second female fixing plastic portion, and a fourth bolt mounting hole is defined in the surface of the lower main insert tube.

In some embodiments, the outer diameter of the male connector matches the inner diameter of the female connector. The male connector is movably inserted inside the female connector. The male connector and the female connector are externally provided with a power connector, and the male connector and the female connector are respectively electrically connected with the power connector through wires.

In some embodiments, the first male connector fixing plastic portion and the second male connector fixing plastic portion are symmetrically distributed semi-cylinders. The first male connector fixing plastic portion includes a plurality of limiting protrusions on one side surface, the second male connector fixing plastic portion includes a plurality of limit slots on one side surface. The limiting protrusions are inserted into the limit slots and thus movably connected thereto. The first male connector fixing plastic portion and the second male connector fixing plastic portion are connected to each other to form a complete cylinder through the limiting protrusions and the limiting slots.

In some embodiments, the inner surface size of the male connector insertion groove matches the outer diameter of the male connector, and the male connector is movably clamped in the male connector insertion grooves opened in the first male connector fixing plastic portion and the second male connector fixing plastic portion. The inner diameter of the rubber sleeve matches the outer diameter of the male connector. The rubber sleeve is movably sleeved on the outer circumference of the male connector. The inner surface size of the rubber sleeve groove matches the outer diameter of the rubber sleeve, and the rubber sleeve is movably clamped in the rubber sleeve grooves opened in the first male connector fixing plastic portion and the second male connector fixing plastic portion.

In some embodiments, the outer diameter dimensions of the first male connector fixing plastic portion and the second male connector fixing plastic portion match the inner diameter of the upper main insertion pipe. The combination of the first male connector fixing plastic portion and the second male connector fixing plastic portion after they are jointed together is movably inserted inside the upper main insertion pipe. The position of the first bolt mounting hole corresponds to that of the second bolt mounting hole. The first fixing bolt is inserted through the inside of the first bolt mounting hole and the second bolt mounting hole. The first male connector fixing plastic portion and the second male connector fixing plastic portion are connected to the upper main insertion pipe through the first fixing bolt.

In some embodiments, the first wire is electrically connected to the male connector. The first LED lamp is electrically connected to the first wire. The first wire passes through the power cord clamping slot. The first LED lamp extends to the outside of the power cord clamping slot. The power cord clamping button is clamped inside the power cord clamping slot to fix the first wire to the upper main insert tube.

In some embodiments, the first female connector fixing plastic portion and the second female connector fixing plastic portion are symmetrically distributed semi-cylinders. The first female connector fixing plastic portion includes a plurality of limiting protrusions on one side surface, the second female connector fixing plastic portion includes a plurality of limit slots on one side surface. The limiting protrusions are inserted into the limit slots and thus movably connected thereto. The first female connector fixing plastic portion and the second female connector fixing plastic portion are connected to each other to form a complete cylinder through the limiting protrusions and the limiting slots.

In some embodiments, the inner surface size of the female connector insertion groove matches the outer diameter size of the female connector, and the female connector is movably clamped in the female connector insertion grooves defined in the first female fixing plastic portion and the second female fixing plastic portion.

In some embodiments, the outer diameter dimensions of the first female connector fixing plastic portion and the second female connector fixing plastic portion match the inner diameter of the lower main insertion pipe. The combination of the first female connector fixing plastic portion and the second female connector fixing plastic portion after they are jointed together is movably inserted inside the lower main insertion pipe. The position of the fourth bolt mounting hole corresponds to that of the third bolt mounting hole. The second fixing bolt is inserted through the inside of the fourth bolt mounting hole and the third bolt mounting hole. The first female connector fixing plastic portion and the second female connector fixing plastic portion are connected to the lower main insertion pipe through the second fixing bolt.

In some embodiments, the second wire is electrically connected to the female connector. The second LED lamp is electrically connected to the female connector. A through hole having an inner diameter matching the outer diameter of the second wire is also defined in the surface of the lower main insertion pipe. The second wire passes through the through hole, the second LED lamp extends to the outside of the through hole, and a clamping button is also clamped in the through hole. The clamping button is clamped inside the through hole to fix the second wire to the lower main insert tube.

Compared with the related art, the present disclosure provides a connector structure for an inner-tube decorative lamp of a Christmas tree, which has the following beneficial effects.

In the connector structure for an inner-tube decorative lamp of a Christmas according to this disclosure, plastic parts are arranged outside the male and female connectors, and the plastic parts are fixedly installed inside the upper main insert tube and the lower main insert tube by bolts. By installing the connector structure in the inner tube of the Christmas tree, the inner tube can effectively protect the connector structure. Furthermore, a rubber sleeve is sleeved on the outside of the male connector. The rubber sleeve is fixedly sleeved on the male connector and then clamped inside the plastic parts. By covering the outer circumference of the male connector with a rubber sleeve, after the male connector is connected to the female connector, the rubber sleeve can stabilize the male connector after installation, thus improving the stability of the male connector and the female connector after they are connected, effectively solving the problem that the existing Christmas tree is relatively large, tall, and shaking of the Christmas tree may cause the cable interface of the connector structure in the inner tube of the Christmas tree unstable so the power can be easily cut off.

### BRIEF DESCRIPTION OF DRAWINGS

FIG. 1 is an overall exploded diagram of the present disclosure.

FIG. 2 is an exploded diagram illustrating the internal structure of the upper main insertion pipe according to the present disclosure.

FIG. 3 is a schematic diagram illustrating the internal structure of the upper main insertion pipe according to the present disclosure.

FIG. 4 is an exploded diagram illustrating the internal structure of the lower main insertion pipe according to the present disclosure.

FIG. 5 is a schematic diagram illustrating the internal structure of the lower main insertion pipe according to the present disclosure.

In the drawings: 1. Male connector; 2. Female connector; 3. First male connector fixing plastic portion; 4. Second male connector fixing plastic portion; 5. Male connector insertion groove; 6. Rubber sleeve groove; 7. First bolt mounting hole; 8. First fixing bolt; 9. Rubber sleeve; 10. First wire; 11. First LED lamp; 12. Upper main insert pipe; 13. Second bolt mounting hole; 14. Power cord clamping slot; 15. Power cord clamping button; 16. First female connector fixing plastic portion; 17. Second female connector fixing plastic portion; part; 18. Female connector insertion groove; 19. Third bolt mounting hole; 20. Second fixing bolt; 21. Second wire; 22. Second LED lamp; 23. Lower main insert pipe; 24. Fourth bolt mounting hole.

### DETAILED DESCRIPTION OF ILLUSTRATIVE EMBODIMENTS

Hereinafter, technical solutions in the embodiments according to the present disclosure will be described in a definite and comprehensive manner in connection with the accompanying drawings in the embodiments according to the present disclosure. Apparently, the embodiments described herein are only a part, rather than all of the embodiments in accordance with the present disclosure. Based on the embodiments of the present disclosure, all other embodiments obtained by those having ordinary skill in the art without investing creative efforts shall all fall in the scope of protection of the present disclosure.

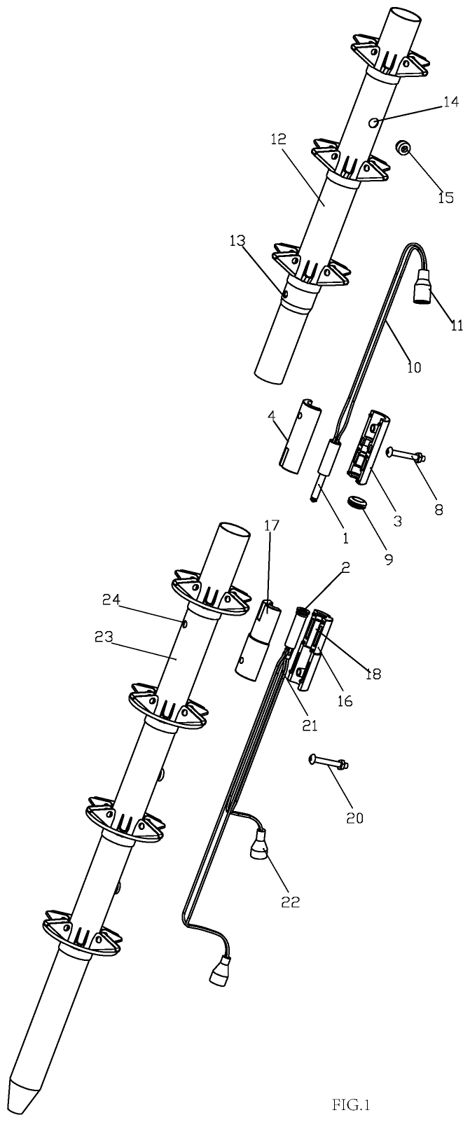

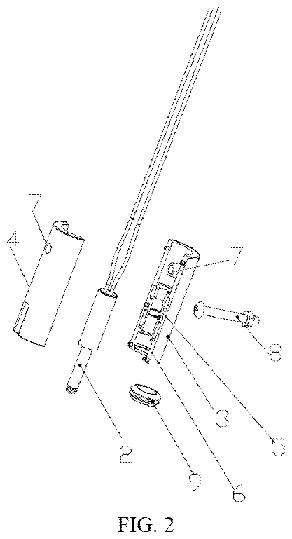

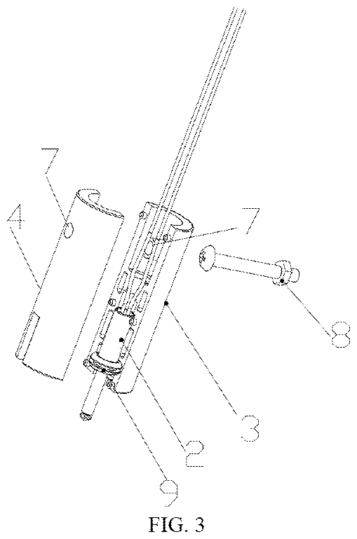

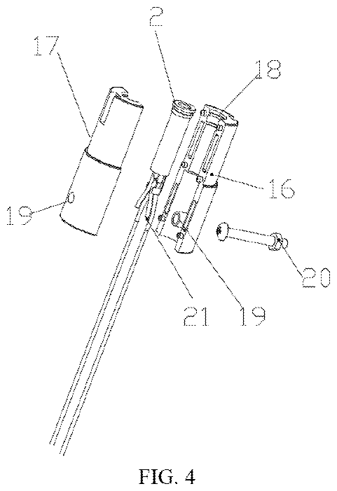

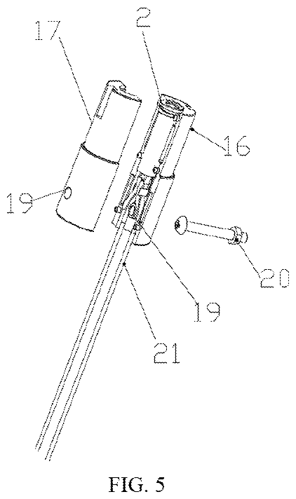

Referring to FIGS. 1 through 5, there is provided a connector structure for an inner-tube decorative lamp of a Christmas tree Christmas tree. The connector structure includes a male connector 1 and a female connector 2. A first male connector fixing plastic portion 3 and a second male connector fixing plastic portion 4 are respectively disposed on both sides of the male connector 1. A male connector insertion groove 5 and a rubber sleeve groove 6 are defined in each of the first male connector fixing plastic portion 3 and the second male connector fixing plastic portion 4. A first bolt mounting hole 7 is defined in a housing of each of the first male connector fixing plastic portion 3 and the second male connector fixing plastic portion 4. A first fixing bolt 8 is arranged to go through the first bolt mounting hole 7. A rubber sleeve 9 is sleeved on the outer circumference of one end of the male connector 1. A first wire 10 is coupled to one end of the male connector 1. A first LED lamp 11 is installed at one end of the first wire 10. An upper main insertion pipe 12 is disposed outside the first male connector fixing plastic portion 3 and the second male connector fixing plastic portion 4. A second bolt mounting hole 13 is defined in the surface of the upper main insertion pipe 12, and a power cord clamping slot 14 is defined in the surface of the upper main insertion pipe 12. A power cord clamping button 15 is disposed on one side of the power cord clamping slot 14. A first female fixing plastic portion 16 and a second female fixing plastic portion 17 are respectively disposed on both sides of the female connector 2. A female connector insertion groove 18 is defined in each of the first female fixing plastic portion 16 and the second female fixing plastic portion 17. A third bolt mounting hole 19 is defined in the housing of each of the first female fixing plastic portion 16 and the second female fixing plastic portion 17. A second fixing bolt 20 is arranged through the third bolt mounting hole 19. One end of the female connector 2 is coupled to a second wire 21, and one end of the second wire 2 is installed with a second LED lamp 22. A lower main insert tube 23 is disposed outside the first female fixing plastic portion 16 and the second female fixing plastic portion 17, and a fourth bolt mounting hole 24 is defined in the surface of the lower main insert tube 23.

In view of the above, the outer diameter of the male connector 1 matches the inner diameter of the female connector 2. The male connector 1 is movably inserted inside the female connector 2. The male connector 1 and the female connector 2 are externally provided with a power connector, and the male connector 1 and the female connector 2 are respectively electrically connected with the power connector through wires. Through the insertion of male connector 1 to female connector 2, the conduction of power can be achieved. The first male connector fixing plastic portion 3 and the second male connector fixing plastic portion 4 are symmetrically distributed semi-cylinders. The first male connector fixing plastic portion 3 includes a plurality of limiting protrusions on one side surface, the second male connector fixing plastic portion 4 includes a plurality of limit slots on one side surface. The limiting protrusions are inserted into the limit slots and thus movably connected thereto. The first male connector fixing plastic portion 3 and the second male connector fixing plastic portion 4 are connected to each other to form a complete cylinder through the limiting protrusions and the limiting slots. The configuration of the limiting protrusions and limiting grooves facilitating the assembly of the plastic portions. The inner surface size of the male connector insertion groove 5 matches the outer diameter of the male connector 1, and the male connector 1 is movably clamped in the male connector insertion grooves 5 opened in the first male connector fixing plastic portion 3 and the second male connector fixing plastic portion 4. The inner diameter of the rubber sleeve 9 matches the outer diameter of the male connector 1. The rubber sleeve 9 is movably sleeved on the outer circumference of the male connector 1. The inner surface size of the rubber sleeve groove 6 matches the outer diameter of the rubber sleeve 9, and the rubber sleeve 9 is movably clamped in the rubber sleeve grooves 6 opened in the first male connector fixing plastic portion 3 and the second male connector fixing plastic portion 4. The male connector 1 is movably clamped inside the male connector insertion groove 5. The first male connector fixing plastic portion 3 and the second male connector fixing plastic portion 4 protect the male connector 1. The outer diameter dimensions of the first male connector fixing plastic portion 3 and the second male connector fixing plastic portion 4 match the inner diameter of the upper main insertion pipe 12. The combination of the first male connector fixing plastic portion 3 and the second male connector fixing plastic portion 4 after they are jointed together is movably inserted inside the upper main insertion pipe 12. The position of the first bolt mounting hole 7 corresponds to that of the second bolt mounting hole 13. The first fixing bolt 8 is inserted through the inside of the first bolt mounting hole 7 and the second bolt mounting hole 13. The first male connector fixing plastic portion 3 and the second male connector fixing plastic portion 4 are connected to the upper main insertion pipe 12 through the first fixing bolt 8. By sheathing the rubber sleeve 9 on the outer circumference of the male connector 1, after the male connector 1 and the female connector 2 are joined, the rubber sleeve 9 can stabilize the male connector 1 after installation, and improve the stability of the connection of the male connector 1 and the female connector 2. The first wire 10 is electrically connected to the male connector 1. The first LED lamp 11 is electrically connected to the first wire 10. The first wire 10 passes through the power cord clamping slot 14. The first LED lamp 11 extends to the outside of the power cord clamping slot 14. The power cord clamping button 15 is clamped inside the power cord clamping slot 14 to fix the first wire 10 to the upper main insert tube 12. Through the electrical connection of the first LED lamp 11, the first wire 10, and the male connector 1, the conduction of power between the first LED lamp 11, the first wire 10, and the male connector 1 is realized. The first female connector fixing plastic portion 16 and the second female connector fixing plastic portion 17 are symmetrically distributed semi-cylinders. The first female connector fixing plastic portion 16 includes a plurality of limiting protrusions on one side surface, the second female connector fixing plastic portion 17 includes a plurality of limit slots on one side surface. The limiting protrusions are inserted into the limit slots and thus movably connected thereto. The first female connector fixing plastic portion 16 and the second female connector fixing plastic portion 17 are connected to each other to form a complete cylinder through the limiting protrusions and the limiting slots. The configuration of the limiting protrusions and limiting grooves facilitates the assembly of the plastic portions. The inner surface size of the female connector insertion groove 18 matches the outer diameter size of the female connector 2, and the female connector 2 is movably clamped in the female connector insertion grooves 18 defined in the first female fixing plastic portion 16 and the second female fixing plastic portion 17. The first female fixing plastic portion 16, and the second female fixing plastic portion 17 protect the female connector 2. The outer diameter dimensions of the first female connector fixing plastic portion 16 and the second female connector fixing plastic portion 17 match the inner diameter of the lower main insertion pipe 23. The combination of the first female connector fixing plastic portion 16 and the second female connector fixing plastic portion 17 after they are jointed together is movably inserted inside the lower main insertion pipe 23. The position of the fourth bolt mounting hole 24 corresponds to that of the third bolt mounting hole 19. The second fixing bolt 20 is inserted through the inside of the fourth bolt mounting hole 24 and the third bolt mounting hole 19. The first female connector fixing plastic portion 16 and the second female connector fixing plastic portion 17 are connected to the lower main insertion pipe 23 through the second fixing bolt 20, thus fixing the plastic portions to the lower main insertion pipe 23. The second wire 21 is electrically connected to the female connector 2. The second LED lamp 22 is electrically connected to the female connector 2. A through hole having an inner diameter matching the outer diameter of the second wire 21 is also defined in the surface of the lower main insertion pipe 23. The second wire 21 passes through the through hole, the second LED lamp 22 extends to the outside of the through hole, and a clamping button is also clamped in the through hole. The clamping button is clamped inside the through hole to fix the second wire 21 to the lower main insert tube 23. Through the electrical connection of the second wire 21, the second LED lamp 22, and the female connector 2, the conduction of power between the second wire 21, the second LED lamp 22, and the female connector 2 is realized.

The working process and installation method of the present disclosure are as follows. In using the connector structure for an inner-tube decorative lamp of a Christmas according to this disclosure, plastic parts are arranged outside the male and female connectors 1 and 2, and the plastic parts are fixedly installed inside the upper main insert tube 21 and the lower main insert tube 23 by bolts. By installing the connector structure composed of plastic portions and connectors in the inner tube of the Christmas tree, the inner tube can effectively protect the connector structure. Furthermore, a rubber sleeve 9 is sleeved on the outside of the male connector 1. The rubber sleeve 9 is fixedly sleeved on the male connector 1 and then clamped inside the plastic portions. By covering the outer circumference of the male connector 1 with the rubber sleeve 9, after the male connector 1 is joined with the female connector 2, the rubber sleeve 9 can stabilize the male connector 1 after installation, thus improving the stability of the male connector 1 and the female connector 2 after they are joined, effectively solving the problem that the existing Christmas tree is relatively large, tall, and shaking of the Christmas tree may cause the cable interface of the connector structure in the inner tube of the Christmas tree unstable so that the power can be easily cut off.

It should be noted that relational terms as used herein, such as “first” and “second”, are merely used to distinguish one entity or operation from another entity or operation, and will not necessarily require or imply any such actual relationships or orders between these entities or operations. Furthermore, terms “include”, “comprise”, or any other variants thereof are intended to encompass a non-exclusive inclusion, so that a process, method, article or device including a series of elements may not only includes those elements, but also may include other elements that are not explicitly listed, or elements inherent to the process, method, article, or device.

Although some embodiments of the present disclosure have been shown and described supra, those of ordinary skill in the art will understand that various changes, modifications, and substitutions can be made to these embodiments without departing from the principle and spirit of the present disclosure, and the scope of the present disclosure is defined in and by the appended claims and their equivalents.

What is claimed is:

1. A connector structure for an inner-tube decorative lamp of a Christmas tree, comprising a male connector and a female connector, wherein a first male connector fixing plastic portion and a second male connector fixing plastic portion are respectively disposed on both sides of the male connector, wherein a male connector insertion groove and a rubber sleeve groove are defined in each of the first male connector fixing plastic portion and the second male connector fixing plastic portion, and a first bolt mounting hole is defined in a housing of each of the first male connector fixing plastic portion and the second male connector fixing plastic portion, wherein a first fixing bolt is disposed through the first bolt mounting holes, wherein a rubber sleeve is sleeved on one end of the male connector, and another end of the male connector is coupled to a first wire, wherein one end of the first wire is installed with a first LED lamp, wherein an upper main insertion pipe is disposed outside the first male connector fixing plastic portion and the second male connector fixing plastic portion, wherein a second bolt mounting hole is defined on a surface of the upper main insert tube, and a power cord clamping slot is opened in a surface of the upper main insert tube, and wherein a power cord clamping button is disposed on one side of the power cord clamping slot;
wherein a first female connector fixing plastic portion and a second female connector fixing plastic portion are respectively disposed on both sides of the female connector, wherein a female connector insertion groove is defined in each of the first female connector fixing plastic portion and the second female connector fixing plastic portion, and a third bolt mounting hole is defined in a surface of a housing of each of the first female connector fixing plastic portion and the second female connector fixing plastic portion, wherein a second fixing bolt is disposed through the third bolt mounting holes, wherein one end of the female connector is connected to a second wire, and one end of the second wire is installed with a second LED lamp, wherein a lower main insert tube is disposed outside the first female connector fixing plastic portion and the second female connector fixing plastic portion, and wherein a fourth bolt mounting hole is defined in a surface of the lower main insert tube.

2. The connector structure as recited in claim 1, wherein an outer diameter of the male connector matches an inner diameter of the female connector, wherein the male connector is movably plugged into the female connector, wherein the male connector and the female connector are externally provided with a power connector, and are each electrically connected to the power connector through a wire.

3. The connector structure as recited in claim 1, wherein the first male connector fixing plastic portion and the second male connector fixing plastic portion are symmetrically distributed semi-cylinders, wherein the first male connector fixing plastic portion comprises a plurality of limiting protrusions disposed on one side surface thereof, and the second male connector fixing plastic portion comprises a plurality of limiting grooves provided in one side surface, wherein the limiting protrusions are movably clamped with the limiting grooves thereof, and wherein the first male connector fixing plastic portion is joined with the second male connector fixing plastic portion to form a complete cylinder through the limiting protrusions and the limiting grooves.

4. The connector structure as recited in claim 1, wherein an inner surface size of the male connector insertion groove matches an outer diameter size of the male connector, and the male connector is movably clamped in the male connector insertion grooves opened in the first male connector fixing plastic portion and the second male connector fixing plastic portion, wherein an inner diameter of the rubber sleeve matches an outer diameter of the male connector and the rubber sleeve is movably sleeved on an outer circumference of the male connector, wherein an inner surface size of the rubber sleeve groove matches an outer diameter of the rubber sleeve and the rubber sleeve is movably clamped in the rubber sleeve grooves opened in the first male connector fixing plastic portion and the second male connector fixing plastic portion.

5. The connector structure as recited in claim 1, wherein an outer diameter of the first male connector fixing plastic portion and the second male connector fixing plastic portion matches an inner diameter of the upper main insert tube, wherein a combination of the first male connector fixing plastic portion and the second male connector fixing plastic portion after they are joined together is movably inserted inside the upper main insert tube, wherein first bolt mounting holes correspond to the second bolt mounting hole in position, wherein the first fixing bolt is inserted through the first bolt mounting holes and the second bolt mounting hole, and wherein the first male connector fixing plastic portion and the second male connector fixing plastic portion are connected to the upper main insert tube through the first fixing bolt.

6. The connector structure as recited in claim 1, wherein the first wire is electrically connected to the male connector, the first LED lamp is electrically connected to the first wire, the first wire passes through the power cord clamping slot, and the power cord clamping button is clamped inside the power cord clamping slot to fix the first wire to the upper main insert tube.

7. The connector structure as recited in claim 1, wherein the first fixed female connector fixing plastic portion and the second female connector fixing plastic portion are symmetrically distributed semi-cylinders, wherein the first female connector fixing plastic portion comprises a plurality of limiting protrusions disposed on one side surface thereof and the second female connector fixing plastic portion comprises a plurality of limiting grooves defined in one side surface thereof, wherein the limiting protrusions are movably clamped with the limiting grooves, and wherein the first female connector fixing plastic portion is joined with the second female connector fixing plastic portion through the limiting protrusions and the limiting grooves to form a complete cylinder.

8. The connector structure as recited in claim 1, wherein an inner surface size of the female connector insert groove matches an outer diameter of the female connector, and the female connector is movably clamped in the female connector insert grooves opened in the first female connector fixing plastic portion and the second female connector fixing plastic portion.

9. The connector structure as recited in claim 1, wherein an outer diameter of the first female connector fixing plastic portion and the second female connector fixing plastic portion matches an inner diameter of the lower main insert tube, wherein a combination of the first female connector fixing plastic portion and the second female connector fixing plastic portion after they are joined is movably inserted inside the lower main insert tube, wherein the fourth bolt mounting hole corresponds to the third bolt mounting holes in position, the second fixing bolt is inserted through the fourth bolt mounting hole and the third bolt mounting holes, and wherein the first female connector fixing plastic portion and the second female connector fixing plastic portion are connected to the lower main insert tube through the second fixing bolt.

10. The connector structure as recited in claim 1, wherein the second wire is electrically connected to the female connector, the second LED lamp is electrically connected to the female connector, a through hole having an inner diameter matching an outer diameter of the second wire is further defined in a surface of a housing of the lower main insert tube, wherein the second wire passes through the through hole, the second LED lamp extends to an outside of the through hole, and wherein a clamping button is also clamped inside the through hole to fix the second wire to the lower main insert tube.
